(19) United States
(12) Patent Application Publication
(10) Pub. No.: US 2012/0296975 A1
(43) Pub. Date: Nov. 22, 2012

(54) SELECTION OF A COMMUNICATION MODE

(76) Inventors: Mahmoud Ghorbel, Nozay (FR); Guy-Bertrand Kamga, Nozay (FR); Sophie Piekarec, Nozay (FR); Marie-Pascale Dupont, Nozay (FR)

(21) Appl. No.: 13/511,189

(22) PCT Filed: Nov. 22, 2010
(86) PCT No.: PCT/FR10/52469

§ 371 Date: Aug. 8, 2012

(30) Foreign Application Priority Data
Nov. 26, 2009 (FR) 0905688

(51) Int. Cl. G06F 15/16

(52) U.S. Cl. 709/204

(57) ABSTRACT

The present invention pertains to a method for selecting a communication mode between a first and a second user of at least one communication network comprising the following steps:
receiving a request sent by the first user in order to be placed into communication with the second user,
determining available communication modes between the first and second user based on at least one status parameter of the second user deduced from the location of said second user and from an activity associated with that location.

The present invention relates to the field of communication networks, and more particularly the selection of a communication mode within a network. The recent development of telecommunications has led to a rise in the number of communication modes that make it possible to put two contacts in contact. Thus, particularly on the professional level, this has made it possible to facilitate exchanges between people who are geographically separated from one another but who work cooperatively. Nonetheless, this multitude of possibilities for contacting a contact may also lead to wasted time if the recipient is not immediately accessible by the chosen communication mode or if the caller must first determine the communication modes whereby the recipient can be reached. State-of-the-art solutions encouraging entering into communication with a contact comprise:—automatic e-mail responses that indicate to the e-mail's sender that the contact is not available (on leave, for example) and the time of his or her next availability (date returning from leave),—telephone answering machines that make it possible to inform the caller of an unavailability. Nonetheless, these solutions only apply to a single communication mode and do not make it possible to determine the best communication mode for reaching a contact.

The purpose of the present invention is therefore to overcome the aforementioned drawbacks of the state of the art and to propose a method that makes it possible to select the best communication mode in order to reach a contact.

Thus, the present invention pertains to a method for selecting a communication mode between a first and a second user of at least one communication network comprising the following steps:
receiving a request sent by the first user in order to be placed into communication with the second user,
determining available communication modes between the first and second user based on at least one status parameter of the second user deduced from the location of said second user and from an activity associated with that location.

According to another aspect of the present invention, the at least one status parameter of the second user comprises the availability of said second user.

According to an additional aspect of the present invention, the second user's availability is determined based on a schedule of said second user saved in a database of the network so that the available communication modes are determined based on the second user's activities.

According to an additional aspect of the present invention, the second user's availability is determined based on the status of said second user within a presence server of at least one communication mode of said second user.

According to an additional aspect of the present invention, the at least one status parameter of the second user takes into account the connection state, with respect to a communication network, of at least one communication device of the second user.

According to an additional aspect, the second user defines the communication modes that are not available based on his or her activity and/or an importance of the communication.

According to an additional aspect of the present invention, the determination of the available communication modes also comprises the determination of at least one status parameter of the first user.

According to another aspect of the present invention, the at least one status parameter of the first user is deduced from the location of said first user.

According to an additional aspect of the present invention, the at least one status parameter of the first user takes into account the communication modes accessible on all of said first user's devices.

According to an additional aspect of the present invention, the communication mode is selected by the first user from among the available communication modes.

According to another aspect of the present invention, the method also comprises a step of selecting a communication mode, from among the available communication modes, based on a preference criterion of the second user.

According to an additional aspect of the present invention, the request sent by the first user comprises at least one communication mode via which said first user wishes to communicate with the second user and wherein the determination of the available communication modes is limited to determining the availability of said at least one communication mode specified within the request.

According to an additional aspect of the present invention, the method also comprises, whenever the second user is not available, an additional step of sending the first user a message comprising the next availability time range of the second user and the communication modes available during said time range.

According to another aspect of the present invention, the method also comprises, whenever the second user is not available, an additional step of sending the first user a message comprising the content information of at least one third user who may be contacted in the event that the second user is unavailable.

The present invention also pertains to a server of a communication network comprising means configured to:
receive a request from a first user of the communication network in order to be placed into communication with a second user of the communication network,
determine available communication modes between the first and second user based on at least one status parameter of the second user deduced from the location of said second user and from an activity associated with that location.

According to another embodiment, the means configured to determine the available communication modes comprise a database within which information is saved regarding the history of the status and the means of communication used by the second user during previous communication requests, means of interacting with a search device, means of processing information received from a device for searching contextual information and user profiles and information contained within the database, and means of interaction with a communication platform managing the various available communication modes.

Other characteristics and benefits of the invention will become apparent from the following description, given with reference to the attached drawings, which by way of a non-limiting limiting example depict one possible embodiment.

In these drawings:

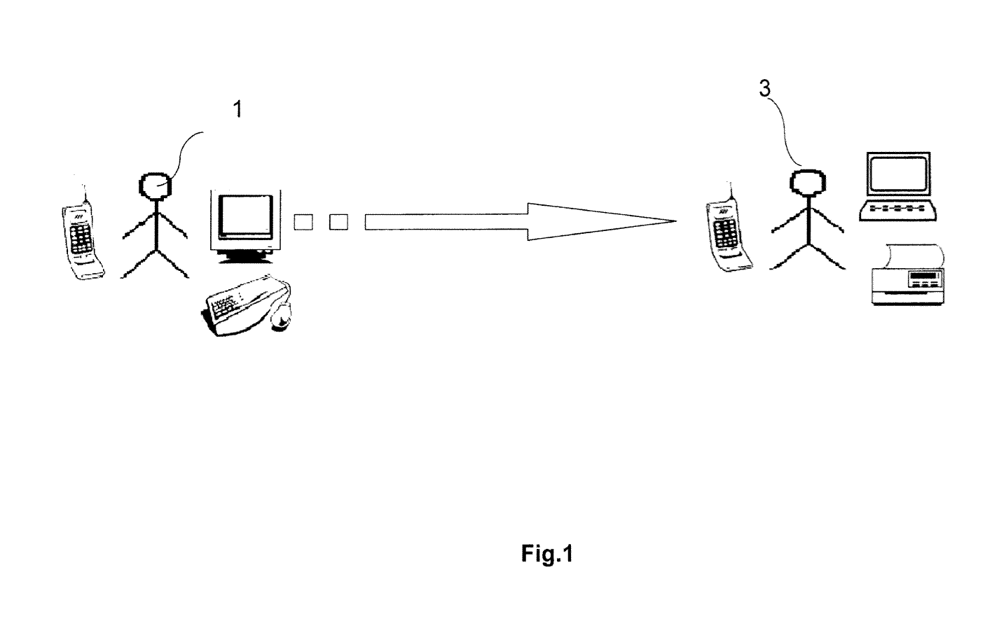

FIG. 1 depicts a diagram of an initiator who wishes to communicate with a recipient;

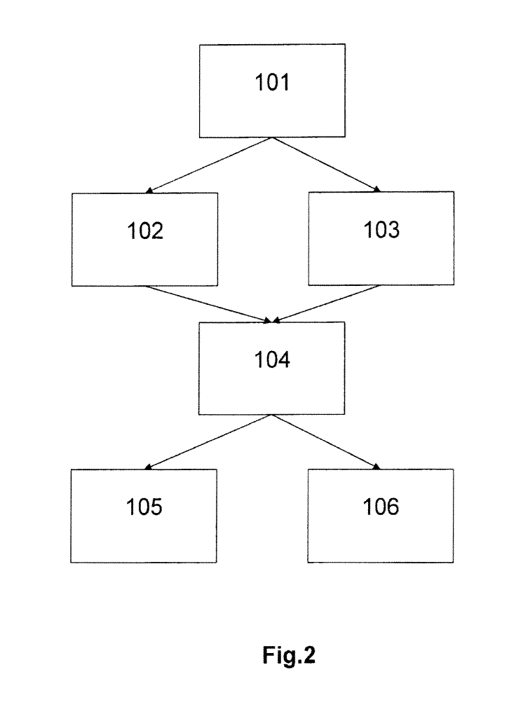

FIG. 2 depicts a block diagram of the various steps of one embodiment of the present invention;

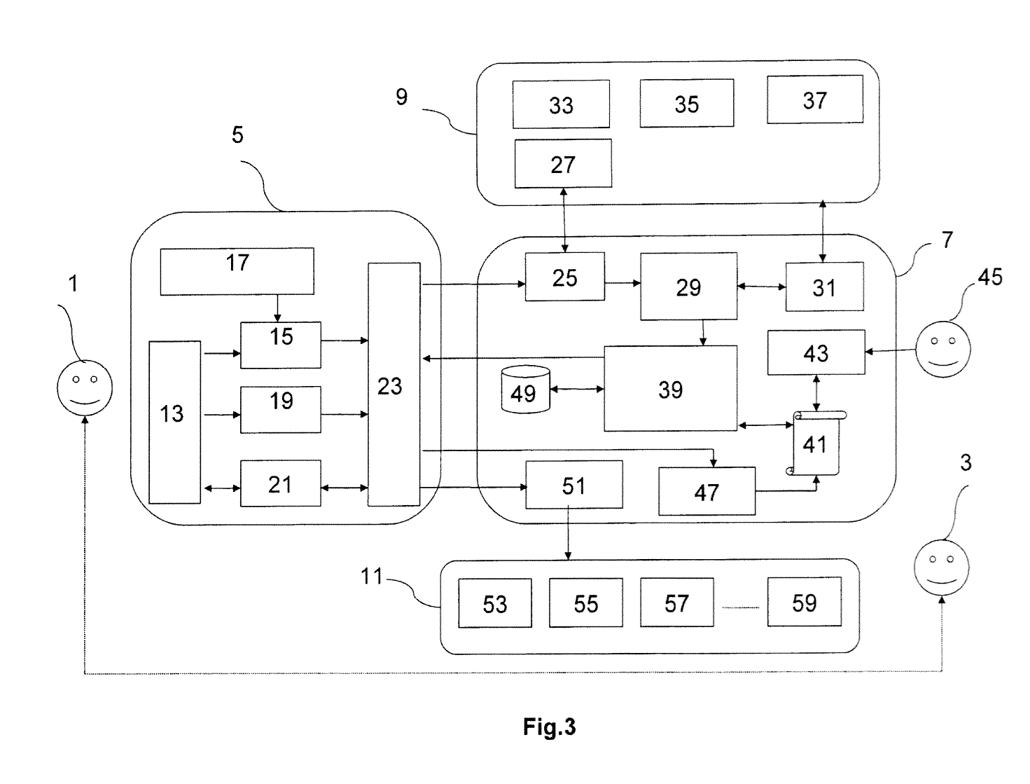

FIG. 3 depicts a synoptic diagram of an apparatus according to one embodiment of the present invention;

In the following description, generally:

The term “communication mode accessible to a user” corresponds to a communication mode for which the user possesses at least one device that makes it possible to use that communication mode.

The term “available communication mode” corresponds to a communication mode whose initiator and recipient both possess devices that make it possible to use that communication mode.

The embodiments of the present invention pertain to determining the best communication mode whenever a user of a communication network wishes to communicate with a contact.

FIG. 1 depicts a diagram of a first user who has multiple communication modes at his or her disposal and who corresponds to an initiator 1 who wishes to communicate with a second user corresponding to the recipient 3.

FIG. 2 depicts the various steps of one embodiment of the present invention.

The first step 101 pertains to the initiator 1 sending a request to establish communication to a server of the network to which it is connected. The request comprises an identifier of the recipient 3. The reception of this request by the server triggers both the determination of the communication modes accessible by the recipient 3 (step 102) and the communication modes accessible by the initiator 1 (step 103).

These steps (102 and 103) for determining the users' accessibility may take into account different information, such as personal information (active communication devices, schedule, etc. saved within a database, as well as determining the connection status on one mode of communication (via a presence server, for example) or the user's location (for example, by locating one of his or her portable communication devices).

Step 104 corresponds to the selection, based on information provided by steps 102 and 103 of the best communication mode in order to establish communication between the initiator 1 and the recipient 3.

In the event that multiple communication modes are accessible by both users, the selection may be carried out based on the preferences of the recipient 3 and/or the initiator 1. These preferences may be saved within a database or, for the initiator 1, a choice comprising the available communication modes may be offered.

If at the end of step 104, a communication mode has been selected, a communication by means of this communication mode is then initiated (step 105).

If no communication mode is accessible, a message is then sent to the initiator 1 (step 106). This message comprises the information that no communication mode is currently accessible, but it may also comprise information about the next time range during which the recipient 3 may be reached (and potentially the scheduling of a delayed call) or potentially the contact information of another user who may be reached while the recipient 3 is inaccessible.

The implementation of one embodiment of the present invention will now be described in detail based on the devices shown in FIG. 3. These devices may be divided into four parts:
a client device 5 corresponding to the part located within the user's communication device (both within the initiator's 1 and the recipient's 3);
a communication server 7;
a device for searching contextual information and user profiles 9;
a communication platform 11;
   the search device 9 and the communication platform 11 being already-existing structures enlisted by the invention's embodiments, with the devices specific to the invention being located within the client device 5 and the server 7.

The user device 5 comprises a graphical interface 13 that enables a user to create a communication request and to receive information regarding that communication request. This interface 13 may also serve to configure preference or privacy settings.

The user device 5 also comprises a local context analyzer 17 that analyzes the information about the user's communication modes such as an Internet connection, a client session initiation protocol, the activation of an instant messaging program, the user's presence status within the instant messaging program, etc.

The graphical interface 13 is connected to a request interface 15 that makes it possible to combine the intentions of the initiator 1 and the local contextual information transmitted by the local context analyzer 17 in order to formulate the request sent to the server. The user may define' his or her preferences via that interface 15; he or she may, for example, specify the type of communication that he or she desires (synchronous or asynchronous, immediate or delayed, urgent or not, important or not, etc.).

The graphical interface 13 is also connected to a privacy interface 19. This privacy interface 19 enables the user to define the communication modes that he or she is authorizing depending on the moment, or on his or her activity. It may, for example, define that he or she can be reached on his or her mobile phone in an emergency, but that he or she does not want his or her phone number to be transmitted to the call's initiator.

The user device 5 also comprises a display manager 21 which organizes the display that corresponds to the information from the server 7. In the event that a communication mode has been selected, it makes it possible to set up communication via this mode.

The exchanges between the user device 5 and the server 7 are carried out through the intermediary of a broker 23 that sends the exchanged information to the concerned device elements.

Within the communication server 7, the request is received by a request analyzer 25, which determines:
the identities of the initiator 1 and the recipient 3;
the contact information (phone number, e-mail address, communication identification parameters, etc.) regarding the initiator 1 and the recipient 3;

This information is obtained from the communication request and from the managery 27 of the search device 9 and is transmitted to an availability detector of the communication modes 29. The role of this availability detector 29 is to define the available communication modes, meaning the communication modes accessible to both users at the time the request is received.

To do so, the availability detector uses both the information collected by the local context analyzer 17 and transmitted within the request, and the information provided by the context manager 31.

The context manager 31 retrieves the context information from the device for searching contextual information and user profiles 9, and particularly from the schedule 33, the presence server 35 or the location device 37.

The information regarding the available communication modes is then transmitted from the availability detector 29 to the communication mode selector 39.

The selection is made between available communication modes using selection rules 41 established from a configuration interface 43 managed by an administrator 45. This configuration interface 43 defines the configuration parameters that make it possible to establish the selection rules 41. These parameters can be reconfigured at any time by the administrator 45. Additionally, the selection rules 41 are established using a privacy manager 47 that communicates with the privacy interface 19 of the user device 5.

This way, the selection rules 41 combine all of the constraints that must be taken into account when selecting the most appropriate communication mode. These rules may be expressed with any programming language and with any logic, such as a first order logic, grammar logic, fuzzy logic, or a neural net, etc.

Additionally, in one embodiment, the selection rules 41 support dynamic variations that make it possible to take into account privacy or configuration changes.

Furthermore, the communication mode selector 39 may use the data that corresponds to the history of communication modes used by the users and saved in a database 49.

Additionally, in the event that no communication mode is available, the system may prompt the initiator 1 to contact another available user who could replace the initial recipient 3 (for example, if the recipient is on leave, one of his or her employees may be designated as the preferred replacement contact in the initial recipient 3's preferences).

The result of the selection is then sent back to the initiator 1 by means of his or her user device 5, and in the event that a communication mode was selected, the corresponding communication is set up on the communication platform 11 by means of a communication interface 51.

The communication platform includes the servers of the communication modes, such as, for example, a telephone server 53, an e-mail server 55, an instant messaging server 57, or a short message (SMS) server 59, etc.

This way, if the selected communication mode is a telephone call, the communication. interface transmits the telephone numbers of both users to the communication platform 11 and in particular to the telephone server 53, and the telephone communication is initiated.

According to one embodiment, a delayed call may also be configured it for example, the recipient is busy but will be available for a communication at a specific time.

In order to better understand the present invention, one example usage will now be described.

An employee of a company, located in his office, wants to communicate with his manager in order to finalize a project. Thus, the employee, using the graphical interface 13 of his computer, sends a communication establishment request. Additionally, in his preferences, the employee has selected to prioritize direct communication modes (telephone, videoconferencing, etc.) and has specified the fact that his communication is not very urgent.

The request is received by the server 7. The contextual information regarding the employee and his manager are then analyzed. The employee's location (in his office) and the corresponding accessible communication modes are then determined. Likewise, the manager's schedule indicates that he or she is traveling and in a meeting, so his communication modes are limited such that only text messages or telephone calls (on his mobile phone) are available. Nonetheless, the manager has selected in his preferences that the telephone calls during his meetings should only be reserved for urgent communications, so text message communication is selected.

Thus, a response is sent to the employee indicating that only text message communication is currently available. Additionally, as his preferences favored direct communications, setting up a delayed telephone communication (whose time corresponds to the time when his manager's meeting ends) is also offered to him.

The employee chooses this second alternative, and a confirmation that a telephone communication will be set up at 6 PM (the time when the meeting ends) is then displayed on his screen.

Additionally, at 6 PM, a message is sent to him to make the phone call. The employee then needs only to confirm his request and the communication is set up within the telephone server.

The embodiments of the present invention therefore enable a user to efficiently and automatically determine the most appropriate communication mode in order to be put into communication with another user while taking into account all of each person's status parameters (accessibility, availability, privacy, preferences, etc.). Thus, the user avoids wasting time as a result of multiple attempts to establish communication with the other person, and is automatically directed to the most appropriate communication mode. This makes it possible, within a company, to improve employees' productivity by simplifying what they have to do to communicate and by efficiently using all of the means of communication at their disposal.

1. A method for selecting a communication mode between a first and a second user of at least one communication network, comprising the following steps:
receiving a request sent by the first user in order to be placed into communication with the second user (101),
determining available communication modes between the first and second user based on at least one status parameter of the second user (102, 103) deduced from the location of said second user and from an activity associated with that location.

2. A method for selecting a communication mode according to claim 1, wherein the, at least one, status parameter of the second user comprises the availability of said second user.

3. A method for selecting a communication mode according to claim 2, wherein the availability of the second user is determined based on a schedule (33) of said second user saved in a database of the network, such that the available communication modes are determined based on the second user's activities.

4. A method for selecting a communication mode according to claim 2 wherein the second user's availability is determined based on the status of said second user within a presence server (35) of at least one communication mode of said second user.

5. A method for selecting a communication mode according to claim 1 wherein the, at least one, status parameter of the second user takes into account the connection state, with respect to a communication network, of at least one communication device of the second user.

6. A method for selecting a communication mode according to claim 1, wherein the second user defines the communication modes that are not available based on his or her activity and/or an importance of the communication.

7. A method for selecting a communication mode according to claim 1, wherein the determination of the available communication modes also comprises the determination of at least one status parameter of the first user.

8. A method for selecting a communication mode according to claim 7, wherein the, at least one, status parameter of the first user is deduced from the location of said first user.

9. A method for selecting a communication mode according to claim 7, wherein the, at least one, status parameter of the first user takes into account the communication modes accessible on all devices of said first user.

10. A method for selecting a communication mode according to claim 1, wherein the communication mode is selected by the first user from among the available communication modes.

11. A method for selecting a communication mode according to claim 1, further comprising a step of selecting a communication mode from among the available communication modes, based on a preference criterion of the second user (104).

12. A method for selecting a communication mode according to claim 1, wherein the request sent by the first user comprises at least one communication mode via which said first user wants to communicate with the second user and wherein the determination of available communication modes is limited to determining the availability of said, at least one, communication mode specified in the request.

13. A method for selecting a communication mode according to claim 1, further comprising, when the second user is not available, an additional step of sending the first user a message comprising the next availability time range of the second user in the available communication modes during said time range.

14. A method for selecting a communication mode according to claim 1, further comprising, when the second user is not available, an additional step of sending the first user a message comprising the contact information of at least one third user who may be contacted in the event that the second user (106) is unavailable.

15. A server of a communication network, comprising means configured to:
receive a request from a first user of the communication network in order to be placed into communication with a second user of the communication network,
determine available communication modes between the first and second user based on at least one status parameter of the second user deduced from the location of said second user and from an activity associated with that location.

16. A server of a communication network according to claim 15, wherein the means configured to determine the available communication modes comprise a database within which information is saved regarding the history of the status and the means of communication used by the second user during previous communication requests, means of interacting with a search device, means of processing information received from a device for searching contextual information and user profiles and information contained within the database, and means of interaction with a communication platform managing the various available communication modes.
